(19) United States
(12) Patent Application Publication
(10) Pub. No.: US 2009/0100840 A1
(43) Pub. Date: Apr. 23, 2009

(54) COMBUSTION CHAMBER WITH OPTIMISED DILUTION AND TURBOMACHINE PROVIDED WITH SAME

(75) Inventors: Jean-Michel Jacques Campion, Moisenay (FR); Michel Pierre Cazalens, Bourron Marlotte (FR); Patrice Andre Commaret, Rubelles (FR); Pascale Rollet, Le Plessis Pate (FR)

Correspondence Address: OBLON, SPIVAK, MCCLELLAND MAIER & NEUSTADT, P.C., 1940 DUKE STREET, ALEXANDRIA, VA, 22314, US

(73) Assignee: SNECMA, Paris (FR)

(21) Appl. No.: 12/256,026

(22) Filed: Oct. 22, 2008

(30) Foreign Application Priority Data
Oct. 22, 2007 (FR) 0707357

(51) Int. Cl. F02C 3/30

(52) U.S. Cl. 60/754

(57) ABSTRACT

The invention relates to the field of turbomachines and concerns a combustion chamber (4) for which the dilution supply is optimised. The invention relates more particularly to optimisation of the position of the dilution holes (30a, 30b) present on the walls (7a, 7b) of the combustion chamber.

The invention relates to the field of turbomachines and concerns a combustion chamber for which the dilution air is optimised.

The invention relates more particularly to optimisation of the position of the dilution holes present in the walls of the combustion chamber.

In the remainder of the description, the terms “upstream” or “downstream” will be used to designate the positions of the structure elements with respect to one another in the axial direction, taking as the reference the direction of flow of the gases. Likewise, the terms “internal” or “radially internal” and “external” or “radially external” will be used to designate the positions of the structure elements with respect to one another in the radial direction, taking as the reference the rotation axis of the turbomachine.

A turbomachine comprises one or more compressors delivering air under pressure to a combustion chamber where the air is mixed with fuel and ignited in order to generate hot combustion gases. These gases flow towards the downstream end of the chamber towards one or more turbines that convert the energy thus received in order to drive the compressor or compressors rotationally and provide the energy necessary, for example, for driving an aircraft.

Typically, a combustion chamber used in aeronautics comprises an internal wall and an external wall, connected together at their upstream end by a chamber end. The chamber end has, spaced apart circumferentially, a plurality of openings each receiving an injection device that enables the mixture of air and fuel to be brought into the chamber.

The combustion chamber is supplied with liquid fuel, mixed with air issuing from a compressor. The liquid fuel is brought to the chamber by injectors in which the fuel is vaporised into fine droplets. This fuel is then burnt within the combustion chamber, which raises the temperature of the air issuing from the compressor.

In general terms, a combustion chamber must meet several requirements and be sized accordingly. It must first of all make it possible to use the fuel in an optimum fashion, that is to say to achieve the highest fuel efficiency for all operating ranges of the engine. It must also supply hot gases to the turbine, the temperature distribution of which at the discharge from the chamber must be compatible with the service life required for the high-pressure turbine and its distributor. It must also degrade the energy of the flow as little as possible and therefore generate a minimal pressure drop between its inlet and outlet. Finally, the parts making up the combustion chamber must have good mechanical strength, which requires cooling the walls of the chamber.

Within the chamber, the combustion takes place in two main phases, to which two zones correspond physically. In a first zone, also referred to as the primary zone, the air/fuel mixture is in stoichiometric proportions or close to these proportions. To produce the air/fuel mixture, the air is injected both at the injectors at the bottom of the chamber and through the walls of the chamber through a first row of orifices referred to as primary holes. Having in the primary zone a mixture under stoichiometric conditions or close thereto makes it possible to obtain good combustion efficiency with maximum reaction speed. Reaction speed means the speed of disappearance of one of the constituents of the air/fuel mixture. Moreover, so that combustion is complete, the air/fuel mixture must reside in this primary zone for a sufficiently long time. The temperature reached by the gases issuing from the combustion in the primary zone is very high. It may achieve for example 2000° C., a temperature incompatible with good mechanical strength of the materials of the turbine and chamber. It is therefore necessary to cool these gases, which is carried out in a second zone. Generally, the primary zone represents approximately the first third of the length of the chamber.

In the second zone, also referred to as the dilution zone, fresh air, referred to as dilution air, issuing from the compressor, is injected into the chamber through its walls by virtue of orifices referred to as dilution holes. The dilution holes can all have the same diameter or different diameters. The dilution air cools the gases issuing from the combustion and prepares the temperature profiles for the high-pressure turbine and its distributor. In addition, a system for cooling the walls of the chamber, for example by film and/or multiperforation, is put in place in order to ensure the service life of the walls of the combustion chamber.

In general terms and as is known, all the primary holes on the one hand and all the dilution holes on the other hand are disposed respectively at the same axial position with respect to the chamber end, the dilution holes being situated downstream of the primary holes. The axial positions of the primary holes and dilution holes, and in particular the distance in the axial direction between the primary and dilution holes, as well as their distribution on the circumference of the walls of the chamber, constitute important parameters on which the designer acts in order to modify the temperature distribution at the discharge from the chamber and to reduce polluting emissions from the chamber.

In the case of chambers with shorter length, the axial distance between the primary holes and the dilution holes becomes small and a phenomenon of unsteady aerodynamic coupling of the air jets issuing from these two types of orifices may appear. Typically, this phenomenon may arise when this axial distance is less than twice the largest diameter of the dilution holes. This phenomenon, which generates a fluttering at the two jets, may give rise to the appearance of combustion instability, having a direct negative impact not only on the performance of the combustion chamber but also on the service life of the walls of the chamber or of the chamber end.

As illustrated in the patents EP 1096205 and EP 1045204, the dilution holes may have different diameters and it is possible to produce several rows of dilution holes succeeding each other axially. These arrangements may make it possible, on certain chambers, to improve the combustion and the temperature profile at the discharge from the chamber, but they are not applicable in the case where the axial distance between the primary holes and their dilution holes is small and therefore do not make it possible to prevent the phenomenon of aerodynamic coupling that appears in this case.

The objective of the invention is, in the case of chambers where the axial distance between the primary holes and the dilution holes is less than twice the largest diameter of the dilution holes, to manage to avoid the appearance of the phenomenon of aerodynamic coupling of air jets issuing from these two types of hole, without increasing the polluting emissions nor having a negative impact on the temperature distribution at the discharge from the chamber, whilst optimising the re-ignition possibilities.

The invention makes it possible to resolve this problem by proposing a novel definition of the position of the dilution holes on the walls of the chamber, this position being defined by a piercing pattern on an angular sector of the walls, which is repeated over the entire circumference of the chamber.

More particularly, the invention concerns a turbomachine combustion chamber comprising a gas flow axis (Y), an annular internal wall and an annular external wall connected together by a chamber end, the internal wall and the external wall being provided with at least one circumferential row of primary holes and at least one circumferential row of dilution holes, the primary holes and dilution holes being distributed regularly over the circumference of the internal and external walls, the primary holes in the internal wall all being situated at the same axial distance with respect to the chamber end and the primary holes in the external wall all being situated at the same axial distance with respect to the chamber end, this chamber being remarkable in that, on at least one of the internal or external walls, the dilution holes are distributed in a first row and at least a second row, in that the dilution holes in the first row are all situated at the same axial distance with respect to the primary holes in the internal or external wall in question, in that the primary holes are situated at the same angular position as at least some of the dilution holes in the second row, and in that the position of the dilution holes in the first and second rows situated angularly between two consecutive primary holes form a repeated pattern over the entire circumference of the internal or external wall in question.

Advantageously, the primary holes and the dilution holes being defined by their axes and diameters, the intersection between the axes of the dilution holes in the first row and the internal or external wall in question forms a first dilution line, and the intersection between the axes of the dilution holes in the second row and the internal or external wall in question forms at least a second dilution line distinct from the dilution line.

Preferentially, a mean dilution line being defined by a circumferential line situated at a distance D′ from the row of primary holes, the distance D′ being equal to the mean of the axial distances between the row of primary holes and the rows of dilution holes, the first dilution line is disposed at an axial distance with respect to the mean dilution line which is lower or equal to twice the diameter of the dilution holes in the first row, and the second dilution lines are disposed at an axial distance with respect to the mean dilution line which is lower or equal to twice the diameter of the dilution holes in the second rows.

The first dilution line can be disposed upstream of the mean dilution line while the second dilution lines are disposed downstream of the mean dilution line, or vice versa.

According to variants of the invention, one of the second dilution lines may be merged with the mean dilution line and/or with the first dilution line.

The diameter of the dilution holes in the first row and the diameter of the dilution holes in the second row may be equal or different.

Preferentially, the combustion chamber according to the invention has an axial length less than or equal to 300 mm but the invention can also apply to all types of combustion chamber given that the relative position of the primary holes and dilution holes may constitute a means of regulating the polluting emissions.

The invention also concerns a turbomachine provided with such a combustion chamber.

The invention will be better understood and other advantages thereof will emerge more clearly in the light of the description of a preferred embodiment and variants, given by way of non-limitative example and made with reference to the accompanying drawings, in which:

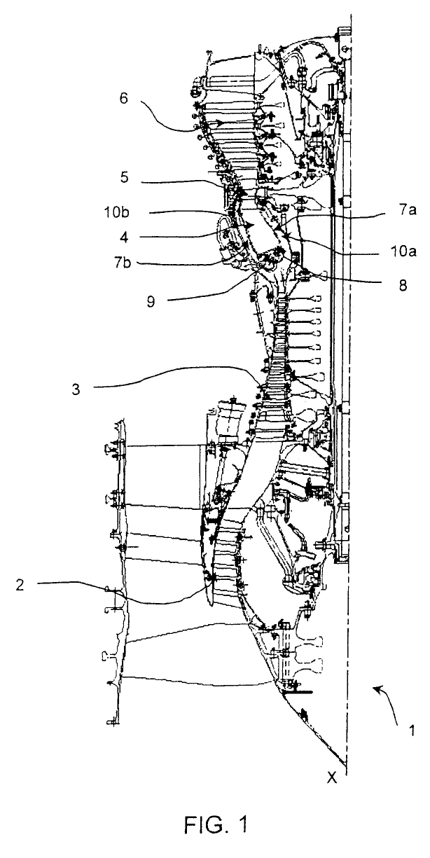

FIG. 1 is a partial schematic view in section of a turbomachine and more precisely an aircraft jet engine;

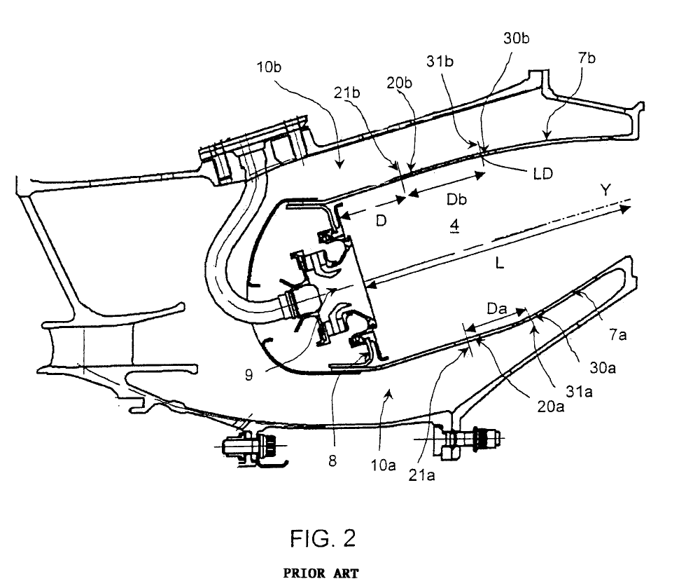

FIG. 2 is a schematic view in section of a combustion chamber according to the prior art;

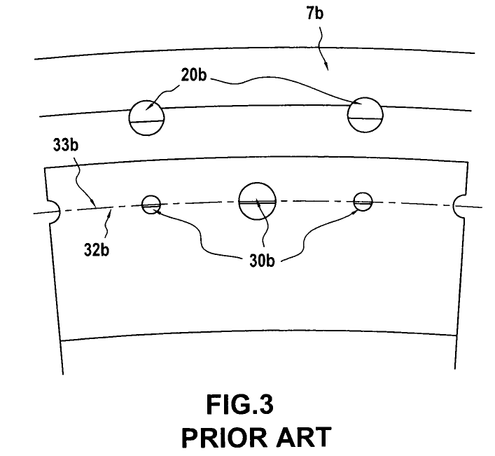

FIG. 3 is a plan view of an angular sector of the external wall of a combustion chamber according to the prior art;

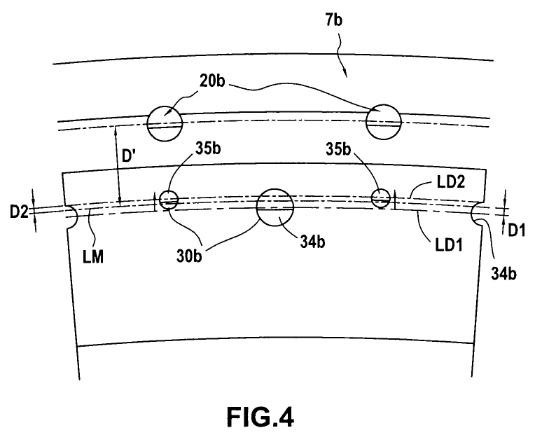

FIG. 4 is a plan view of an angular sector of the external wall of a combustion chamber according to the invention;

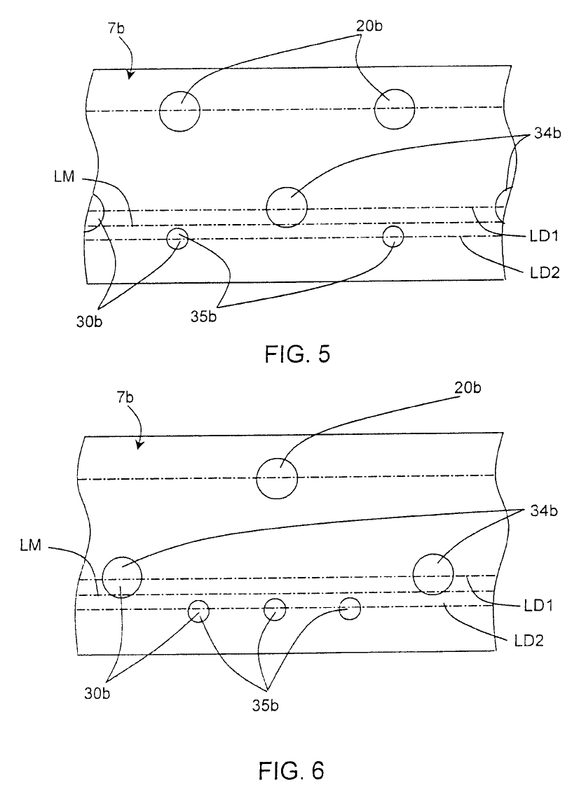

FIGS. 5 to 9 are plan views of an angular sector of the external wall of a combustion chamber according to different embodiments of the invention.

FIG. 1 shows in section an overall view of a turbomachine 1, for example an aircraft jet engine, the rotation axis of which is marked X. The turbomachine 1 comprises a low-pressure compressor 2, a high-pressure compressor 3, a combustion chamber 4, a high-pressure turbine 5 and a low-pressure turbine 6. The combustion chamber 4 is of the annular type and is delimited by an internal annular wall 7a and an external annular wall 7b spaced apart radially with respect to the axis X, and connected at their upstream end to an annular chamber end 8. The chamber end 8 comprises a plurality of openings, regularly spaced apart circumferentially. In each of these openings an injection device 9 is mounted. The combustion gases flow downstream in the combustion chamber 4 and then supply the turbines 5 and 6 which drive respectively the compressors 3 and 2 disposed upstream from the chamber end 8, by means respectively of two shafts. The high-pressure compressor 3 supplies the injection devices 9 with air, as well as two annular spaces 10a and 10b disposed radially respectively inside and outside the combustion chamber 4. The air introduced into the combustion chamber 4 participates in the vaporisation of the fuel and its combustion. The air circulating outside the walls of the combustion chamber 4 participate firstly in the combustion and secondly in the cooling of the walls 4a and 4b and of the gases issuing from the combustion. For this purpose the air enters the chamber respectively through a first row of orifices referred to as primary holes and through a second series of orifices referred to as dilution holes. The dilution holes may all have the same diameter or different diameters. These two types of orifice are shown in FIG. 2.

FIG. 2 shows more precisely a cross section of a combustion chamber 4 according to the prior art. The total length of the combustion chamber is marked L.

The internal 7a and external 7b walls of the chamber 4 are both provided with a circumferential row of primary holes 20a and respectively 20b, the axes of which are marked 21a and respectively 21b. Downstream of these primary holes 20a, 20b there is disposed a circumferential row of dilution holes 30a, 30b, the axes of which are marked 31a and respectively 31b. On the internal wall 7a, all the primary holes 20a are situated at the same distance D from the chamber end 8. The same applies to the dilution holes 30a, and to the primary 20b and dilution 30b holes on the external wall 7b. The intersection of the axes 21a of the primary holes 20a and of the internal wall 7a forms a circumferential line referred to as the dilution line LD. The same applies to the intersection of the axes 21b and of the internal walls 7b, to the intersection of the axes 31a and of the internal wall 7a and to the intersection of the axes 31b and of the external wall 7b. The distance between the axes 21a of the primary holes 20a and the axes 31a of the dilution holes 30a is marked Da. The distance between the axes 21b of the primary holes 20b and the axes 31b of the dilution holes 30b is marked Db. Here the distances Da and Db are sufficient, that is to say greater than or equal to twice the largest diameter of the dilution holes, to prevent any risk of aerodynamic coupling between the air jets issuing from the primary holes 20a and the dilution holes 30a on the one hand and between the air jets issuing from the primary holes 20b and the dilution holes 30b on the other hand.

FIG. 3 shows a plan view of an angular sector of the external wall 7b of the combustion chamber 4 according to the prior art. On this sector, there can be seen two of the primary holes 20b, as well as several dilution holes 30b. All the primary holes have the same diameter while the dilution holes may, as illustrated here, have different diameters. The primary holes 20b are distributed in a regular fashion over the circumference of the external wall 7b and each primary hole is aligned with a fuel injector, that is to say, for a given injector, the corresponding primary hole is situated at the same angular position. The dilution holes are also distributed in a regular fashion over the circumference of the external wall 7b. For each primary hole 20b, a dilution hole 30b is disposed at the same angular position, that is to say, along the axis Y of the chamber, each primary hole is aligned with a dilution hole 30b. In the case shown in FIG. 3, it is the dilution holes 30b whose diameter is the smallest that are aligned with the primary holes 20b. The other dilution holes 30b, namely those that have the largest diameter, are interposed between the small-diameter dilution holes and disposed at equal distances from these holes. The large-diameter dilution holes are also situated at equal distances from the closest primary holes 20b. In the example shown, there is only one small-diameter dilution hole situated circumferentially between two consecutive large-diameter dilution holes, but there could be several of them, distributed in a regular fashion over the circumference of the external wall 7b.

When the design objectives concerning for example reducing the polluting emissions or the temperature profiles at the outlet from the combustion chamber cause the distance D to be reduced, the primary holes 20b and the dilution holes 30b are then too close. Generally this corresponds to an axial distance less than twice the largest diameter of the dilution holes. In this case, the phenomenon of aerodynamic coupling of the air jets issuing from these two types of hole may appear. It was discovered that, by modifying the positioning of the dilution holes in an appropriate fashion, this phenomenon could be prevented.

FIG. 4 shows a plan view of an angular sector of the external wall 7b of a combustion chamber 4 according to the invention. On this sector two of the three primary holes 20b are shown as well as several dilution holes 30b. The position of the primary holes 20b remains unchanged with respect to the prior art, only the positioning of the dilution holes 30b changes. The dilution holes 30b are distributed regularly over the circumference of the external wall 7b and can be all of the same diameter or, as illustrated here, of different diameters. In our example the dilution holes 30b are distributed in a first set of small-diameter holes and a second set of large-diameter holes. The small-diameter dilution holes 35b are disposed so as to be aligned with the primary holes 20b, that is to say they are at the same angular position. The large-diameter dilution holes 34b are disposed between the primary holes 20b, at equal distances from the closest small-diameter dilution holes. Unlike the prior art, this set of dilution holes is no longer situated at the same distance Db from the primary holes 20b. Two circumferential rows of dilution holes can be seen: a first row 34b formed by the dilution holes situated angularly between the primary holes 20b, forming a first dilution line LD1, a second row 35b formed by the small-diameter dilution holes, forming a second dilution line LD2. Compared with the prior art, it can be seen that the dilution holes in the second row 35b are offset towards the upstream end, that is to say towards the primary hole, with respect to the dilution holes in the first row 34b. A mean external dilution line LM situated at a distance D′ from the row of primary holes 20b is defined, the distance D′ being equal to the mean of the axial distances between the row of primary holes and the rows of dilution holes. The mean line is therefore disposed between the dilution holes LD1 and LD2.

The distance D′ defining the position of the mean dilution line LM is determined in the same way as in the prior art. The optimisation of the dilution is achieved by modifying the position of the axes of the dilution holes in the first row 34b and the second row 35b with respect to the mean dilution line. Knowing D′, it is then possible to position the dilution holes of these two rows so as to eliminate the phenomenon of aerodynamic coupling while complying with the imperatives with which the chamber must comply. For this optimisation to be effective and not to interfere with the functioning of the chamber, the axes of the dilution holes in the first row 34b must be situated, with respect to the mean dilution line, at a distance C1 less than twice the diameter. The same applies to the position of the axes of the dilution holes in the second row 35b, which must be situated, with respect to the mean dilution line, at a distance D2 less than twice their diameter. In addition, the distance D′ must not be modified.

Other embodiments are possible, some of which are illustrated in FIGS. 5 to 9.

In FIG. 5, the embodiment depicted is similar to the embodiment described previously. It differs solely in that the dilution holes in the second row 35b are no longer offset towards the upstream end with respect to the dilution holes in the first row 34b, but towards the downstream end. In the embodiments described up till now, the first and second rows 34b, 35b comprised the same number of dilution holes. Variants with a different number of dilution holes in each group are possible.

For example, FIG. 6 shows a variant where the second row 35b comprises three times more dilution holes as the first row 34b. In this example, the dilution, as before, is defined by the position of the mean external dilution line LM, around which there are positioned first and second dilution lines LD1 and LD2 on which the axes of the dilution holes of the two rows aligned. The axes of the first row 34b of dilution holes are positioned on the first dilution line LD1, situated upstream of the mean line 33b, that is to say on the same side as the primary holes 20b. The axes of the second row 35b of dilution holes are positioned on the second dilution line LD2, downstream of the mean line 33b. Between two consecutive dilution holes in the first row 34b there are disposed three dilution holes in the second row 35b. Among these three holes the one that is situated in a central position is aligned with one of the primary holes 20b, that is to say has the same angular position. All the dilution holes remain regularly distributed on the circumference of the external wall 7b.

The dilution holes in the second group 35b can have their axis intercepting the external wall 7b so as to form a single dilution line LD2, as described up till now. However, their axes may also be positioned at different distances with respect to the mean external dilution line LM. In this case, the intersection of their axis with the external wall 7b no longer forms one but several dilution lines.

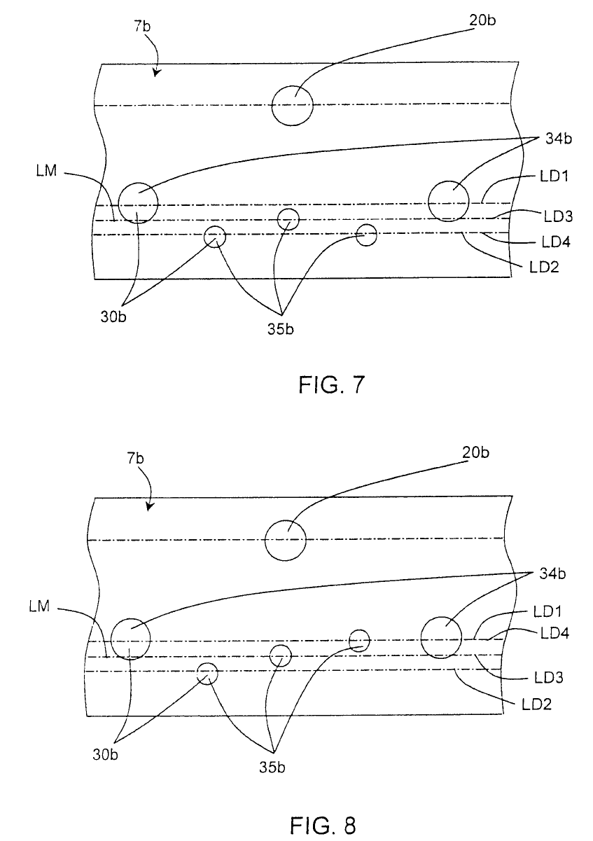

FIGS. 7 to 9 illustrate example embodiments of the invention in such a case.

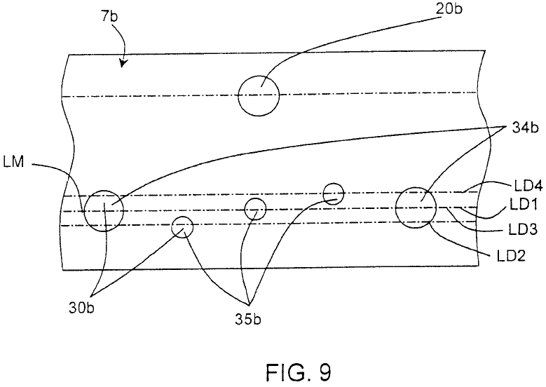

In these examples, the second row 35b of dilution holes also comprises three times more holes as the first row 34b. The dilution holes in the second row 35b are distributed over three distinct dilution lines LD2, LD3, LD4. In a first variant, one of these dilution lines may be merged with the mean dilution line LM, as illustrated in FIG. 7. In another variant, illustrated in FIG. 8, one of these dilution lines may be merged with the dilution line LD1 formed by the axes of the dilution holes of the first row 34b. Moreover, the dilution lines LD2, LD3 and LD4 may all be situated downstream of the dilution holes in the first row 34b, but they may also be distributed on each side of the dilution holes in this first row 34b, as illustrated in FIG. 9, or all situated upstream of the first row 34b.

In all the embodiments described previously, the relative positions of the primary holes 20b and dilution holes 30b may be entirely defined by giving the position of each of the holes on an angular sector of the external wall 7b. More precisely, it suffices to give the position of each hole on the angular sector situated between the axes of two consecutive primary holes 20b, the pattern thus obtained then being reproduced over the entire circumference of the external wall 7b.

The above description has been given by taking the external wall 7b as an example application but the invention also applies in the same way to the internal wall 7a.

1. A turbomachine combustion chamber comprising a gas flow axis (Y), an annular internal wall (7a) and an annular external wall (7b), connected together by a chamber end (8), the internal wall (7a) and the external wall (7b) being provided respectively with at least one circumferential row of primary holes (20a, 20b) and at least one circumferential row of dilution holes (30a, 30b), the primary holes (20a, 20b) and dilution holes (30a, 30b) being distributed regularly over the circumference of the internal (7a) and external (7b) walls, the primary holes (20a) in the internal wall (7a) all being situated at the same axial distance (D) with respect to the chamber end (8), the primary holes (20b) in the external wall (7b) all being situated at the same axial distance with respect to the chamber end (8), characterised in that,
on at least one of the internal (7a) or external (7b) walls, the dilution holes (30a, 30b) are distributed in a first row (34b) and at least a second row (35b),
in that the dilution holes in the first row (34b) are all situated at the same distance along the axis (Y) of the chamber with respect to the primary holes in the internal (7a) or external (7b) wall in question,
in that the primary holes are situated at the same angular position as at least some of the dilution holes in the second row (35b), and in that the position of the dilution holes in the first (34b) and second (35b) rows situated angularly between two consecutive primary holes (20a) form a repeated pattern over the entire circumference of the internal (7a) or external (7b) wall in question.

2. A combustion chamber according to claim 1, characterised in that
the primary holes (20b) and the dilution holes being defined by their axes (21a, 21b, 31a, 31b) and diameters,
the intersection between the axes of the dilution holes in the first row (34b) and the internal (7a) or external (7b) wall in question forms a first dilution line (LD1), and the intersection between the axes of the dilution holes in the second rows (35b) and the internal (7a) or external (7b) wall in question forms at least a second dilution line (LD2, LD3, LD4) distinct from the dilution line (LD1).

3. A combustion chamber according to claim 2, characterised in that
a mean dilution line (LM) being defined by a circumferential line situated at a distance D′ from the row of primary holes 20b, the distance D′ being equal to the mean of the axial distances between the row of primary holes and the rows of dilution holes, the first dilution line (LD1) is disposed at an axial distance with respect to the mean dilution line (LM) which is lower or equal to twice the diameter of the dilution holes in the first row (34b),
and in that the second dilution lines (LD2, LD3, LD4) are disposed at an axial distance with respect to the mean dilution line (33b) which is lower or equal to twice the diameter of the dilution holes in the second rows (35b).

4. A combustion chamber according to one of claims 2 or 3, characterised in that
the first dilution line (LD1) is disposed upstream of the mean dilution line (LM)
and in that the second dilution lines (LD2, LD3, LD4) are disposed downstream of the mean dilution line (LM).

5. A combustion chamber according to one of claims 2 or 3, characterised in that
the first dilution line (LD1) is disposed downstream of the mean dilution line (LM)
and in that the second dilution lines (LD2, LD3, LD4) are disposed upstream of the mean dilution line (LM).

6. A combustion chamber according to one of claims 2 or 3, characterised in that
the first dilution line (LD1) is disposed upstream of the mean dilution line (LM)
and in that one of the second dilution lines (LD2, LD3, LD4) is merged with the mean dilution line (LM), the remaining second dilution lines being disposed downstream of the mean dilution line (LM).

7. A combustion chamber according to one of claims 2 or 3, characterised in that
the first dilution line (LD1) is disposed downstream of the mean dilution line (LM)
and in that one of the second dilution lines (LD2, LD3, LD4) is merged with the mean dilution line (LM), the remaining second dilution lines being disposed upstream of the mean dilution line (LM).

8. A combustion chamber according to one of claims 2 or 3, characterised in that
the first dilution line (LD1) is disposed upstream of the mean dilution line (LM)
and in that at least one of the second dilution lines (LD2, LD3, LD4) is disposed upstream of the mean dilution line (LM), the remaining second dilution lines being disposed downstream of the mean dilution line.

9. A combustion chamber according to one of claims 2 or 3, characterised in that
the first dilution line (LD1) is disposed downstream of the mean dilution line (LM)
and in that at least one of the second dilution lines (LD2, LD3, LD4) is disposed downstream of the mean dilution line (LM), the remaining second dilution lines being disposed downstream of the mean dilution line.

10. A combustion chamber according to one of claims 2 or 3, characterised in that
the first dilution line (LD1) is disposed upstream of the mean dilution line (LM)
and in that one of the second dilution lines (LD2, LD3, LD4) is merged with the first dilution line (LD1), the remaining second dilution lines being disposed downstream of the mean dilution line (LM).

11. A combustion chamber according to one of claims 2 or 3, characterised in that
the first dilution line (LD1) is disposed downstream of the mean dilution line (LM)
and in that one of the second dilution lines (LD2, LD3, LD4) is merged with the first dilution line (LD1), the remaining second dilution lines being disposed upstream of the mean dilution line (LM).

12. A combustion chamber according to one of claims 2 or 3, characterised in that
the first dilution line (LD1) is disposed upstream of the mean dilution line (LM)
and in that one of the second dilution lines (LD2, LD3, LD4) is merged with the first dilution line (LD1), another of the second dilution lines is merged with the mean dilution line (LM), the remaining second dilution lines being disposed downstream of the mean dilution line.

13. A combustion chamber according to one of claims 2 or 3, characterised in that
the first dilution line (LD1) is disposed downstream of the mean dilution line (LM)
and in that one of the second dilution lines (LD2, LD3, LD4) is merged with the first dilution line (LD1), another of the second dilution lines is merged with the mean dilution line (LM), the remaining second dilution lines being disposed upstream of the mean dilution line.

14. A combustion chamber according to one of claims 2 or 3, characterised in that the first dilution line (LD1) is disposed upstream of the mean dilution line (LM)
and in that one of the second dilution lines (LD2, LD3, LD4) is merged with the first dilution line (LD1), at least one of the other second dilution lines (LD2, LD3, LD4) being disposed upstream of the mean dilution line (LM), the remaining second dilution lines being disposed downstream of the mean dilution line.

15. A combustion chamber according to one of claims 2 or 3, characterised in that
the first dilution line (LD1) is disposed downstream of the mean dilution line (LM)
and in that one of the second dilution lines (LD2, LD3, LD4) is merged with the first dilution line (LD1), at least one of the other second dilution lines being disposed downstream of the mean dilution line (LM), the remaining second dilution lines being disposed upstream of the mean dilution line.

16. A combustion chamber according to any one of the preceding claims, characterised in that the diameter of the dilution holes in the first row (34b) and the diameter of the dilution holes in the second row (35b) are different.

17. A turbomachine provided with a combustion chamber according to any one of the preceding claims.
